(19) United States
(12) Patent Application Publication
(10) Pub. No.: US 2026/0221653 A1
(43) Pub. Date: Jul. 30, 2026

(54) IMPROVED STEERING OF AN ANTENNA BEAM

(71) Applicant: Telefonaktiebolaget LM Ericsson (publ), Stockholm (SE)

(72) Inventors: Sam Agneessens, Torslanda (SE); Jian Yang, Mölndal (SE); Enlin Wang, Göteborg (SE); Ashraf Uz Zaman, Askim (SE)

(21) Appl. No.: 19/145,411

(22) PCT Filed: Jan. 13, 2023
(86) PCT No.: PCT/SE2023/050036

§ 371 Date: Jul. 2, 2025

(51) Int. Cl. H01Q 5/307; H01P 1/06; H01P 3/123

(52) U.S. Cl. CPC H01Q 5/307; H01P 1/06; H01P 3/123

(57) ABSTRACT

An antenna feed arrangement comprising an antenna port, a waveguide port and a reconfigurable waveguide arrangement connecting the antenna port and the waveguide port. The feed arrangement comprises a fixed part that comprises the waveguide port, the fixed part having a fixed position in the feed arrangement, and a movable part that in turn comprises the antenna port, where the movable part is movable relative the fixed part by means of pairs of variable adjacent surfaces that are adapted to move relative each other. One surface in at least one pair of variable adjacent surfaces comprises a conductive material with a periodic or quasi-periodic structure formed by a number of protruding elements arranged or designed to stop propagation of microwave energy to pass across a gap between the variable adjacent surfaces.

### TECHNICAL FIELD

The present disclosure relates to an antenna feed arrangement comprising an antenna port, a waveguide port and a reconfigurable waveguide arrangement connecting the antenna port and the waveguide port.

### BACKGROUND

Microwave links are an essential part of many telecom networks, being considered as a good option thanks to advantages such as fast time to market, low cost of installment, large capacities, and reliability. For most links, there are performance limitations such as signal fades, which for example can be caused by rain, multipath, and mast sway, for example induced by wind, earthquakes or by thermal deformation, which apart from causing events with deep fading, might induce rapid fluctuations in the received signal power. Fixed point-to-point links rely on a high system gain between transmitter and receiver to overcome the regular path loss due to spherical spreading of the waves and to overcome signal fades in the channel.

At mm Wave frequencies, in particular E-band (60 GHz to 90 GHz), W-band (75 to 110 GHz) and D-band (110 GHz to 170 GHz), the impact of rain and path loss, spherical wave spreading, becomes more severe. Furthermore, a power amplifier's ability to generate high output power is limited. To achieve high system gain, large high gain antennas can be used to achieve high system gain between a transmitter and a receiver in a microwave link to overcome regular path loss due to spherical spreading of the waves and to overcome signal fades in the channel, which occur for the above reasons.

High gain antennas imply narrow antenna beams, which means that a microwave link will become more sensitive to deviations from an optimal antenna alignment and to movement of the mounting structure. Such a movement can be induced by wind, thermal deformation, or any other source of vibrations. The fading dips caused by misalignment can be very steep due to the pattern of the antenna.

There are different ways to handle misalignment, for example mounting the antenna lower in the mast to get less movement, but this limits deployment options, and is not cost-effective since only a part of the mast is used. Another example is to strengthen structure, but this is an expensive and slow process, which also may be visually unappealing. Antennas with beamsteering capabilities can also be to mitigate misalignment problems arising from the movement of the structure on which the antenna is mounted. Pencil-beam antennas for point to point links are typically reflector based, due to their high gain, good efficiency, low cost, and low sidelobe characteristic.

Steering of a reflector can be achieved by moving the reflector or whole antenna. But this means a large mass needs to be moved. In case dual-reflector antennas are used, it is possible to opt for movement of the sub-reflector, which requires less mass to be moved. A downside of a dual-reflector system is that the sub-reflector and its support structure effectively reduces the aperture of the antenna, since it is placed in front of the primary reflector. When adding the required mechanics such as for example motors, cables, additional support etc., to enable movement of the sub-reflector, this problem becomes worse or the antenna becomes very bulky if all the extra parts are placed behind the sub-reflector. In view of this, steering the beam by moving the feed seems more appealing. When the feed is at the center of the reflector dish, the phase center of the feed is at the focus of the sub-reflector in order to have maximum antenna efficiency and low sidelobes. When the feed is moved away from the center point, referred to as off-focus feeding, the main beam of the whole reflector antenna steered to an angle away from boresight.

When beamsteering is achieved by moving the feeder antenna, it is difficult to keep the interface to the rest of the system, such as the radio, stationary since it is important to avoid bending of cables or waveguides at mmWave frequencies to ensure reliability and keeping time to failure low.

It is therefore desired to provide improved means for alignment of a reflector antenna.

### SUMMARY

The object of the present disclosure is to provide improved means for alignment of a reflector antenna.

This object is obtained by means of an antenna feed arrangement comprising an antenna port, a waveguide port and a reconfigurable waveguide arrangement connecting the antenna port and the waveguide port. The feed arrangement comprises a fixed part that comprises the waveguide port, said fixed part having a fixed position in the feed arrangement, and a movable part that in turn comprises the antenna port. The movable part is movable relative the fixed part by means of pairs of variable adjacent surfaces that are adapted to move relative each other. One surface in at least one pair of variable adjacent surfaces at least partly comprises a conductive material with a periodic or quasi-periodic structure formed by a number of protruding elements arranged or designed to stop propagation of microwave energy to pass across a gap between the variable adjacent surfaces in at least one direction, at least in one intended frequency band of operation.

This means that energy leakage and undesirable resonances between adjacent surfaces that are adapted to move relative each other, which seriously affects the performance of the corresponding antenna, is counteracted.

According to some aspects, the feed arrangement comprises at least one waveguide port, at least one fixed part and at least one movable part. This means that there can be several parts and antenna ports.

According to some aspects, at least one movable part at least partly comprises at least one reconfigurable waveguide conductor part that is comprised in the reconfigurable waveguide arrangement and connects to the antenna port such that when said movable part is moved, the antenna port is moved relative the waveguide port that is kept fixed while maintaining the connection between the antenna port and the waveguide port via the waveguide arrangement.

This means that energy leakage and undesirable resonances between adjacent surfaces that are adapted to move relative each other, which seriously affects the performance of the corresponding antenna, is counteracted.

According to some aspects, the feed arrangement comprises pairs of fixed adjacent surfaces that are adapted to have a fixed position relative each other, where one surface in at least one pair of fixed adjacent surfaces comprises a surface of a conductive material with a periodic or quasi-periodic structure formed by the protruding elements.

This means that not only variable adjacent surfaces that are adapted to move relative each other can be equipped with the periodic or quasi-periodic structure formed by the protruding elements, but also fixed adjacent surfaces that are adapted to have a fixed position relative each other.

According to some aspects, the antenna feed arrangement comprises a first layer that is a fixed part and comprises an electrically conducting first main surface, a second layer that is a fixed part and comprises an electrically conducting second main surface that faces the first main surface, and a third layer that is positioned between the first main surface and the second main surface. The third layer comprises at least one movable part and at least one fixed part, where the reconfigurable waveguide arrangement is formed in the movable part and the fixed part, forming a connection between the antenna port and a waveguide port. A movement of the movable part changes the position of the antenna port relative the waveguide port while the connection via the reconfigurable waveguide arrangement between the antenna port and the waveguide port is maintained.

According to some further aspects, a movement of the movable part a circular movement around a center axis.

This would allow for a horn antenna, a high gain antenna, or other directional antenna, to tilt while keeping the interface to the radio, the waveguide port, stationary.

According to some aspects, the antenna feed arrangement comprises a U-shaped fixed part that comprises at least one waveguide port, and a movable part that is slidably arranged in the fixed part and comprises the antenna port. At least one reconfigurable waveguide conductor part is at least partly formed in the movable part. A movement of the movable part changes the position of the antenna port relative the waveguide port while maintaining the connection via the reconfigurable waveguide arrangement between the antenna port) and the waveguide port.

According to some further aspects, the fixed part comprises a bottom part, a first wall part and a second wall part. The movable part is slidably arranged on the bottom part and between the wall parts, where the first wall part comprises a first waveguide port and the second wall part comprises a second waveguide port. The waveguide ports are positioned at different distances from the bottom layer, where the movable part comprises a bottom layer, a top layer, and an intermediate layer positioned between the bottom layer and the top layer. The bottom layer comprises a first reconfigurable waveguide arrangement that is adapted to form a part of a connection between the first waveguide port and the antenna port, the intermediate layer comprises a second reconfigurable waveguide arrangement that is adapted to form a part of a connection between the second waveguide port and the antenna port, and the top layer comprises the antenna port.

This means that the fixed part comprises two waveguide ports and two corresponding reconfigurable waveguide conductor parts are at least partly formed in the movable part. A movement of the movable part changes the position of the antenna port relative the waveguide ports.

According to some aspects, the antenna feed arrangement comprises a fixed bottom part, a movable top part and at least two intermediate movable parts. At least a first intermediate movable part is adapted to move together with the movable top part along a first extension and at least two intermediate movable parts, including said first intermediate movable part, are adapted to move together with the movable top part along a second extension, perpendicular to the first extension.

In this manner, a two-dimensional movement can be accomplished.

Moreover, this object is also obtained by means of radio link antennas, radio link nodes, radio link arrangements and methods. These are all associated with the above advantages.

### BRIEF DESCRIPTION OF THE DRAWINGS

The present disclosure will now be described more in detail with reference to the appended drawings, where:

FIG. 1 shows a schematic view of point to point radio link arrangements;

FIG. 2A shows a schematic perspective view of a first example of an antenna feed arrangement according to the present disclosure;

FIG. 2B shows a schematic perspective view of details in FIG. 2A;

FIG. 2C shows a schematic perspective view of details in FIG. 2A;

FIG. 2D shows a schematic top section view of FIG. 2A where the antenna feed arrangement is in a first position;

FIG. 2E shows a schematic top section view of FIG. 2A where the antenna feed arrangement is in a second position;

FIG. 3A shows a schematic perspective view of a second example of an antenna feed arrangement according to the present disclosure;

FIG. 3B shows a schematic top section view of FIG. 3A where the antenna feed arrangement is in a first position;

FIG. 3C shows a schematic top section view of FIG. 3A where the antenna feed arrangement is in a second position;

FIG. 4A shows a schematic perspective view of a third example of an antenna feed arrangement according to the present disclosure;

FIG. 4B shows a schematic top section view of FIG. 4A where the antenna feed arrangement is in a first position;

FIG. 4C shows a schematic top section view of FIG. 4A where the antenna feed arrangement is in a second position;

FIG. 5A shows a schematic perspective view of a fourth example of an antenna feed arrangement according to the present disclosure;

FIG. 5B shows a schematic top section view of FIG. 5A where the antenna feed arrangement is in a first position;

FIG. 5C shows a schematic top section view of FIG. 5A where the antenna feed arrangement is in a second position;

FIG. 5D shows a schematic top section view of FIG. 5A where the antenna feed arrangement is in a third position;

FIG. 6A shows a schematic perspective view of a radio link antenna;

FIG. 6B shows a schematic side view of the radio link antenna according to FIG. 6A;

FIG. 7 shows details of a protruding element; and

FIG. 8 illustrates methods according to the present disclosure.

### DETAILED DESCRIPTION

Aspects of the present disclosure will now be described more fully with reference to the accompanying drawings. The different devices, computer programs and methods disclosed herein can, however, be realized in many different forms and should not be construed as being limited to the aspects set forth herein. Like numbers in the drawings refer to like elements throughout.

The terminology used herein is for describing aspects of the disclosure only and is not intended to limit the invention. As used herein, the singular forms “a”, “an” and “the” are intended to include the plural forms as well, unless the context clearly indicates otherwise.

With reference to FIG. 1, there is a point to point radio link arrangement 100 comprising a first link node 101A and a second link node 101B which are arranged to communicate with each other via a communication link 106. The first link node 101A comprises a first transceiver (TRX) arrangement 103A and a first radio link antenna 102A, being adapted for a first main beam 104A, and the second link node 101B comprises a second TRX 103B and a second radio link antenna 102B, being adapted for a second main beam 104B. The communication link 106 may be disturbed, for example due to weather events 105 such as wind, precipitation, heat and cold, where mast movement 130A, 130B may result. The TRXs 103A, 103B can according to some aspects be regarded as radio units.

In order to counteract this and to maintain the communication link 106, it is possible to employ beamsteering antennas. These are modifications of standard antennas, in this example reflector antennas, that achieve steering of the respective main beam 104A, 104B by changing the configuration of the antenna system. This is for example achieved by moving or rotating the feeder antenna, by changing the pattern of the feeder antenna, focal plane array, or by modifying how the radiation coming from the feeder antenna is collimated by the reflector system. For example, by moving the reflector or a sub-reflector, or by modifying its shape.

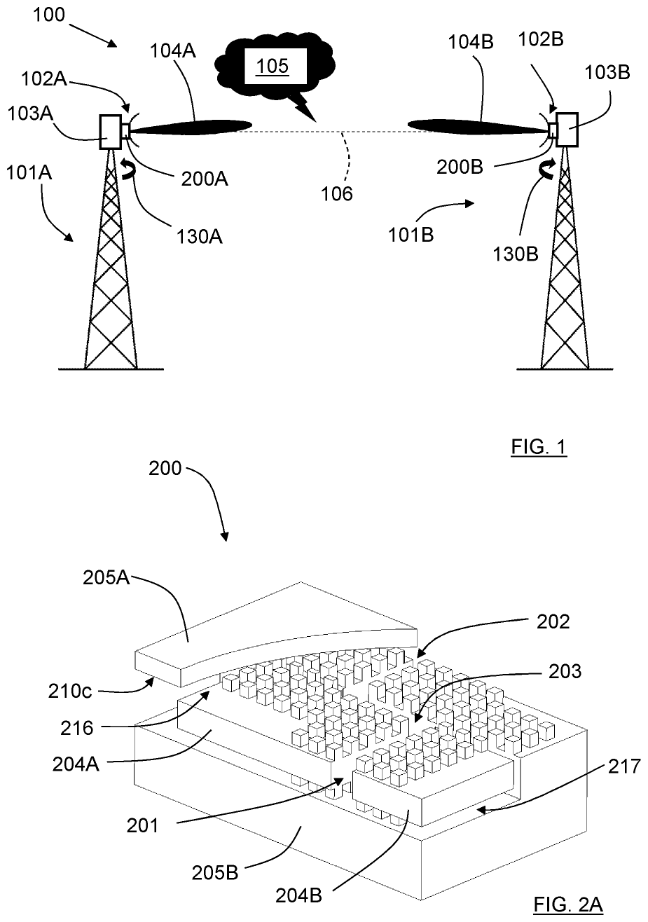

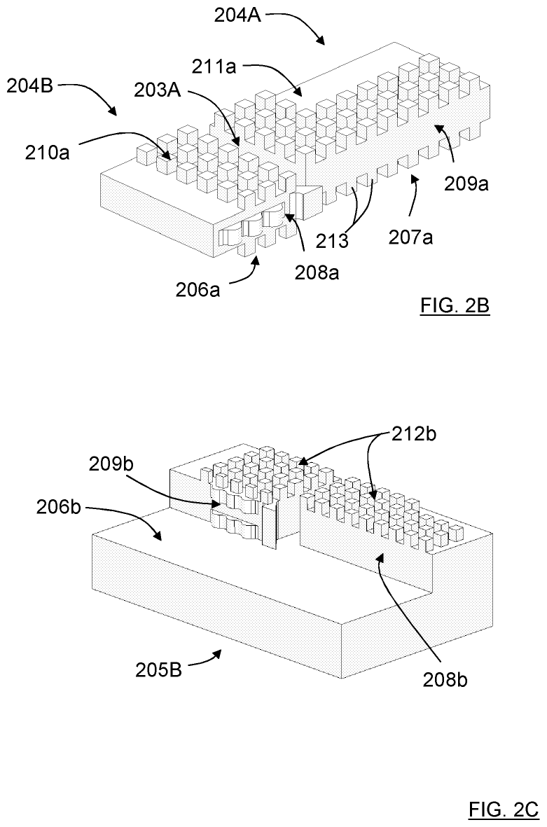

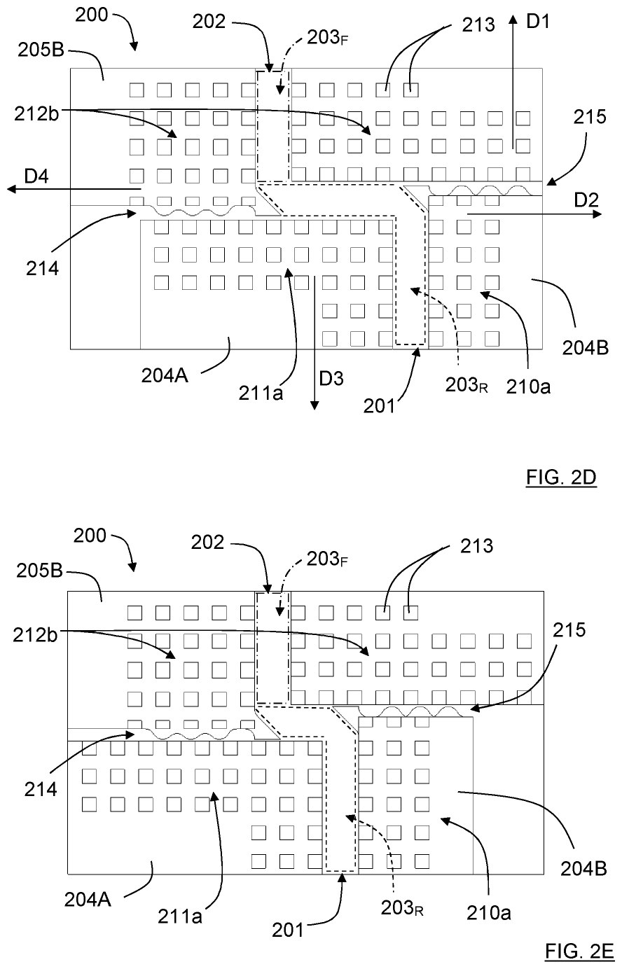

For this purpose, with reference also to FIG. 2A-FIG. 2E that illustrate a first example, there is an antenna feed arrangement 200, 200A, 200B comprising an antenna port 201, a waveguide port 202 and a reconfigurable waveguide arrangement 203R, 203F connecting the antenna port 201 and the waveguide port 202. The feed arrangement 200 comprises a fixed part 205A, 205B that comprises the waveguide port 202, said fixed part 205A, 205B having a fixed position in the feed arrangement 200, and a movable part 204A, 204B that in turn comprises the antenna port 201, where said movable part 204A, 204B is movable relative said fixed part 205A, 205B by means of pairs of variable adjacent surfaces 206a, 206b; 207a, 206b; 208a, 208b; 209a, 209b; 210a, 210c; 211a, 210c that are adapted to move relative each other.

This means that the waveguide port 202 will remain stationary while the antenna port 201 moves, where the antenna port 201 for example can be connected to a reflector feed arrangement which thus can be move such that beemsteering is enabled, while the waveguide port 202 is fixed.

According to some aspects, at least one movable part 204A, 204B at least partly comprises at least one reconfigurable waveguide conductor part 203R that is comprised in the reconfigurable waveguide arrangement 203R, 203F and connects to the antenna port 201 such that when said movable part 204A, 204B is moved, the antenna port 201 is moved relative the waveguide port 202 that is kept fixed while maintaining the connection between the antenna port 201 and the waveguide port 202 via the waveguide arrangement 203.

However, between the adjacent surfaces 206a, 206b; 207a, 206b; 208a, 208b; 209a, 209b; 210a, 210c; 211a, 210c that are adapted to move relative each other, there are resulting gaps 214, 215, 216, 217. At the Millimeter-Wave frequencies, even a very small gap can cause very serious energy leakage and undesirable resonances, which seriously affects the performance of the corresponding antenna.

In order to counteract this, according to the present disclosure, one surface 206a, 207a, 208a, 209b, 210a, 211a in at least one pair of variable adjacent surfaces 206a, 206b; 207a, 206b; 208a, 208b; 209a, 209b; 210a, 210c; 211a, 210c at least partly comprises a conductive material with a periodic or quasi-periodic structure formed by a number of protruding elements 213 arranged or designed to stop propagation of microwave energy to pass across a gap 214, 215, 216, 217 between the variable adjacent surfaces 206a, 206b; 207a, 206b; 208a, 208b; 209a, 209b; 210a, 210c; 211a, 210c in at least one direction D1, D2, D3, D4, at least in one intended frequency band of operation. According to some aspects, one surface in at least one pair of variable adjacent surfaces of course means that there can be several such surfaces when there are several pairs of variable adjacent surfaces, each pair having such a surface.

Here one surface in at least one pair of variable adjacent surfaces is equipped with the protruding elements. This means that there may be surfaces that move relative each other that are not equipped with the protruding elements. In the description we can specify where we prefer to have the protruding elements.

The protruding elements 213 are according to some aspects formed in a gap wageguide (GW) technology where pins 213 are used to form artificial magnetic conductor (AMC), which can be combined with a perfect electrical conductor (PEC) to form stop bands. Its contactless characteristics make it achieve manufacturing flexibility, easy assembling and cost effectiveness. This technology is used in many mmWave antennas and other microwave applications, see for example EP 2311134 B1 and US2020365962 A1.

FIG. 7 shows an example geometry for a protruding element 213 suitable for the E-band and its dispersion diagram. It can be seen that there is an 80 μm gap h_{gap} between the protruding element 213 and the upper surface, and the stop band can be formed within 50.86 GHz~157.52 GHz. This means that the variable adjacent surfaces 206a, 206b; 207a, 206b; 208a, 208b; 209a, 209b; 210a, 210c; 211a, 210c are not in mechanical contact with each other, and where the distance between them is maintained by any suitable means such as wheel and/or tracks. The protruding elements 231 thus protrude from one surface but do not reach all the way to the opposing surface. Examples of other typical measures for a stop band formed within 50.86 GHz~157.52 GHz are hₚ=0.7 mm and wₚ=0.6 mm. Where applicable, a typical measure for dₚ=1.2 mm.

Of course, the size of the protruding element 213 can be adjusted for any desired stop band.

According to some aspects, the feed arrangement 200 comprises at least one waveguide port 202, at least one fixed part 205A, 205B and at least one movable part 204A, 204B. This means that there can be several parts and antenna ports.

According to some aspects, the feed arrangement 200 comprise pairs of fixed adjacent surfaces 212b, 210c; 310a, 310b that are adapted to have a fixed position relative each other, where one surface 210b, 212b in at least one pair of fixed adjacent surfaces 212b, 210c; 310a, 310b comprises a surface of a conductive material with a periodic or quasi-periodic structure formed by the protruding elements 213.

This means that not only variable adjacent surfaces 206a, 206b; 207a, 206b; 208a, 208b; 209a, 209b; 210a, 210c; 211a, 210c that are adapted to move relative each other can be equipped with the periodic or quasi-periodic structure formed by the protruding elements 213, but also fixed adjacent surfaces 212b, 210c; 310a, 310b that are adapted to have a fixed position relative each other.

FIG. 2B and FIG. 2C show schematic perspective views of details in FIG. 2A.

In FIG. 2D and FIG. 2E the beemsteering mechanism is exemplified, where it is assumed that the antenna port 201 is connected to a suitable kind of antenna feed. Two movable parts 204A, 204B are adapted to move as one part from a first position in FIG. 2D to a second position in FIG. 2E such that a reconfigurable waveguide conductor part 203R in the reconfigurable waveguide arrangement 203R, 203F is changed, being shortened, and the antenna port 201 is moved together with the movable parts 204A, 204B. The waveguide conductor part 203F that is connected to the waveguide port 202 remains fixed.

In the example shown in FIG. 2A-FIG. 2E, and for all other examples as well, not all variable adjacent surfaces 206a, 206b; 207a, 206b; 208a, 208b; 209a, 209b; 210a, 210c; 211a, 210c that are adapted to move relative each other need to be equipped with the periodic or quasi-periodic structure formed by the protruding elements 213, but at least one pair of variable adjacent surfaces 206a, 206b; 207a, 206b; 208a, 208b; 209a, 209b; 210a, 210c; 211a, 210c that at least partly comprises the periodic or quasi-periodic structure formed by the protruding elements 213. According to some aspects, only one surface 206a, 207a, 210a, 211a in the largest variable adjacent surfaces 206a, 206b; 207a, 206b; 210a, 210c; 211a, 210c that are equipped with the protruding elements 213, while the smaller, perpendicular surfaces 208a, 208b; 209a, 209b do not need to be equipped with the protruding elements 213 since the leakage at these corresponding gaps 214, 215 is considered small enough to be neglected. This is of course only an option, and which surface in a pair of adjacent surfaces that should be equipped with the protruding elements 213, and to which extent, may of course vary.

The principle of the antenna feed arrangement described above can be implemented in many ways, and a few examples will be provided in the following.

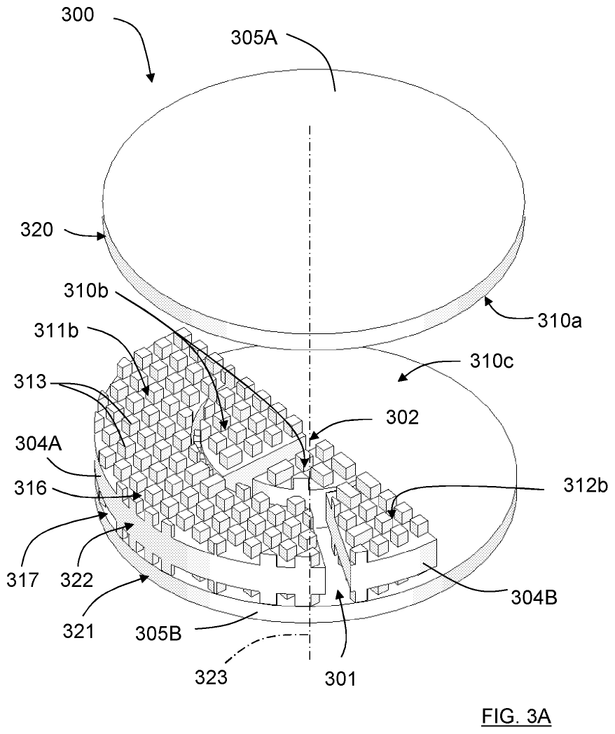

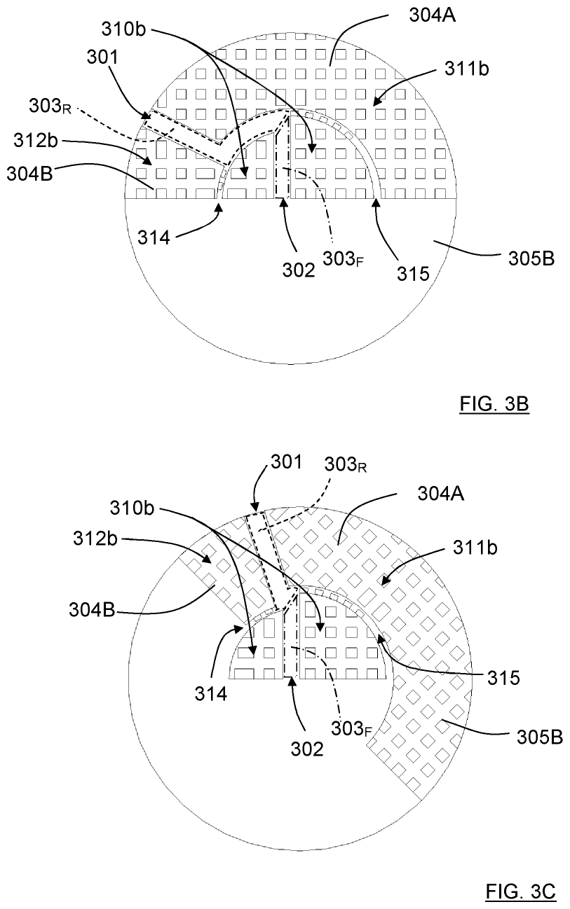

With reference to FIG. 3A, FIG. 3B and FIG. 3C, there is a second example of an antenna feed arrangement 300. According to some aspects, the antenna feed arrangement 300 comprises a first layer 320 that is a fixed part 305A and comprises an electrically conducting first main surface 310a, a second layer 321 that is a fixed part 305B and comprises an electrically conducting second main surface 310c that faces the first main surface 310a, and a third layer 322 that is positioned between the first main surface 310a and the second main surface 310c. The third layer 322 comprises at least one movable part 304A, 304B, in this example two movable parts 304A, 304B, and at least one fixed part 305B. In this example, the fixed part 305B of the third layer 322 is formed integrally with the fixed part 305A of the second layer 321.

The reconfigurable waveguide arrangement 303R, 303F is formed in the movable part 304A, 304B and the fixed part 305A, 305B, forming a connection between the antenna port 301 and a waveguide port 302, where a movement of the movable part 304A, 304B changes the position of the antenna port 301 relative the waveguide port 302 while the connection via the reconfigurable waveguide arrangement 303R, 303F between the antenna port 301 and the waveguide port 302 is maintained.

According to some further aspects, a movement of the movable part 304A, 304B is a circular movement around a center axis 323. In this example, v as depicted in FIG. 3A-FIG. 3C.

In FIG. 3B and FIG. 3C, the beemsteering mechanism is exemplified, where it is assumed that the antenna port 301 is connected to a suitable kind of antenna feed. The movable parts 304A, 304B of the third layer 322 are adapted to move as one part from a first position in FIG. 3B to a second position in FIG. 3C such that a reconfigurable waveguide conductor part 303R in the reconfigurable waveguide arrangement 303R, 303F is changed, being shortened, and the antenna port 301 is moved together with the movable parts 304A, 304B. The waveguide conductor part 303F that is connected to the waveguide port 302 remains fixed.

This would allow for a horn antenna, a high gain antenna, or other directional antenna, to tilt while keeping the interface to the radio, the waveguide port 302, stationary.

It should be noted that this only is an example of such a layered antenna feed arrangement 300 where the movement of the movable part 304A, 304B is a circular movement around a center axis 323. For example, the fixed part of the third layer that comprises the waveguide port can be a peripheral part while the movable parts of the third layer that comprises the antenna port are central parts.

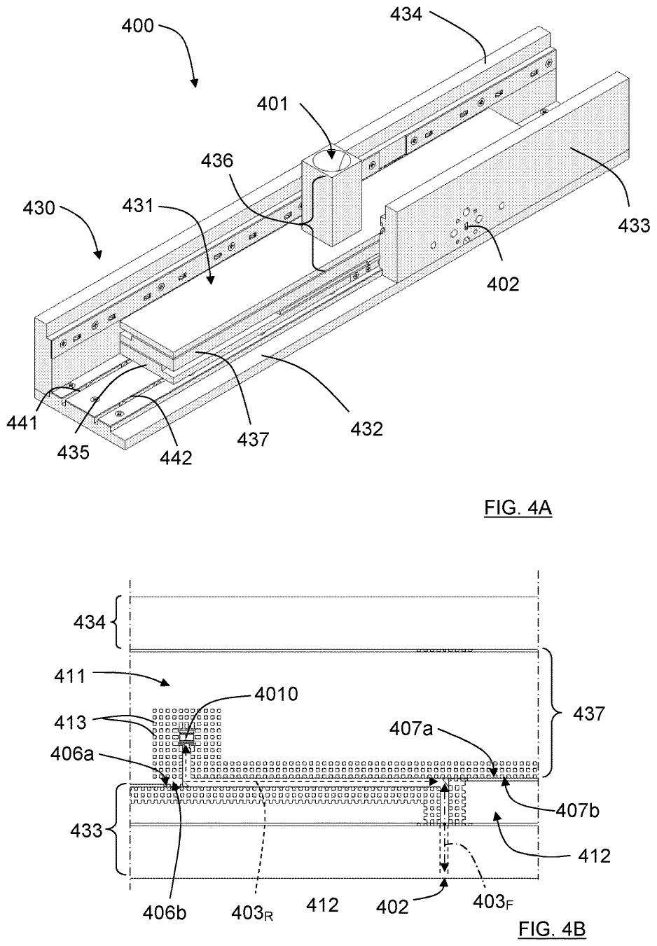

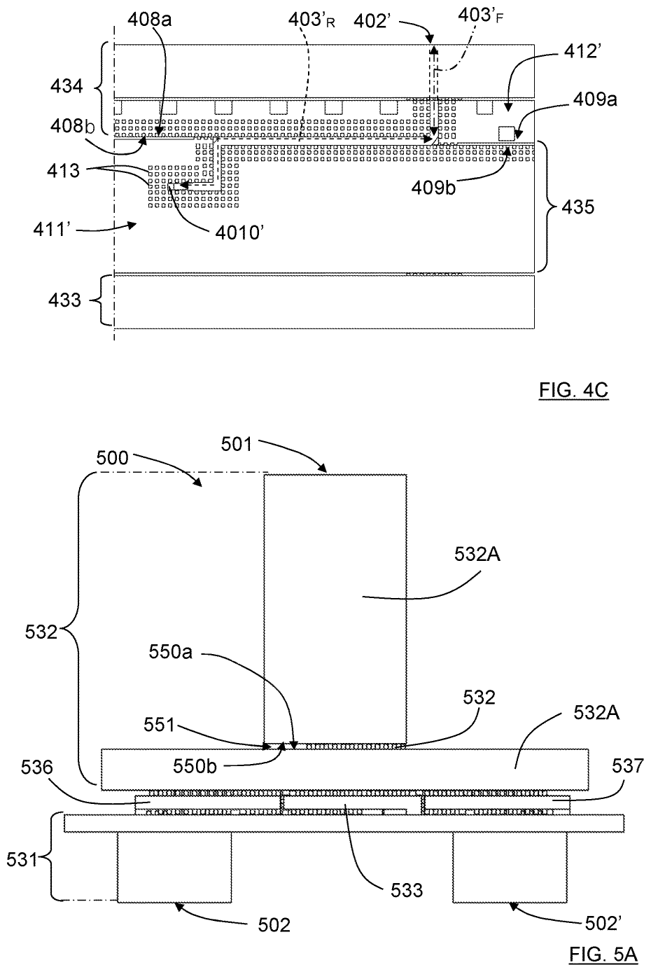

With reference to FIG. 4A, FIG. 4B and FIG. 4C, there is a third example of an antenna feed arrangement 400. According to some aspects, the antenna feed arrangement 400 comprises a U-shaped fixed part 430 that comprises at least one waveguide port 402, 402′, and a movable part 431 that is slidably arranged in the fixed part 430 and comprises the antenna port 401. At least one reconfigurable waveguide conductor part 403R, 403′R is at least partly formed in the movable part 431. A movement of the movable part 431 changes the position of the antenna port 401 relative the waveguide port 402, 402′ while maintaining the connection via the reconfigurable waveguide arrangement 403R, 403′R, 403F, 403′F between the antenna port 401 and the waveguide port 402, 402′.

In this example, the fixed part 430 comprises two waveguide ports 402, 402′ and two corresponding reconfigurable waveguide conductor parts 403R, 403′R are at least partly formed in the movable part 431, where a movement of the movable part 431 changes the position of the antenna port 401 relative the waveguide ports 402, 402′. The example will be described more in detail below.

According to some aspects, the fixed part 430 comprises a bottom part 432, a first wall part 433 and a second wall part 434, where the movable part 431 is slidably arranged on the bottom part 432 and between the wall parts 433, 434, where the first wall part 433 comprise a first waveguide port 401 and the second wall part 434 comprises a second waveguide port 402′. The waveguide ports 402, 402′ are positioned at different distances from the bottom layer 432, and the movable part 431 comprises a bottom layer 435, a top layer 436, and an intermediate layer 437 positioned between the bottom layer 435 and the top layer 436.

The bottom layer 435 comprises a first reconfigurable waveguide arrangement 403R that is adapted to form a part of a connection between the first waveguide port 402 and the antenna port 401, the intermediate layer 437 comprises a second reconfigurable waveguide arrangement 403′R that is adapted to form a part of a connection between the second waveguide port 402′ and the antenna port 401, and the top layer 436 comprises the antenna port 401.

According to some aspects, the bottom part 432 comprises tracks 441, 442 which provide guidance for the movable part 431 that for example may comprise wheels that run in the tracks 441, 442. In this manner, the bottom layer 435 can be maintained at a distance from the bottom part 432. In this manner, all gaps h_{gap} between the protruding elements 213 and the adjacent surface as mentioned previously can be accomplished. The different layers 435, 436, 437 may be separated in a similar manner, or by means of rims that slide in tracks in the wall parts 433, 434. This is applicable for all examples, and many other ways to accomplish the gaps h_{gap} in this example and all other examples are of course conceivable.

In FIG. 4B and FIG. 4C, the beemsteering mechanism is exemplified, where it is assumed that the antenna port 401 is connected to a suitable kind of antenna feed. The antenna port 401 may constitute an antenna feed in itself.

In FIG. 4B, a top view of the intermediate layer 437 in the fixed part 430 is shown. It is evident that if the intermediate layer 437 is moved to the right in the Figure, a reconfigurable waveguide conductor part 403R in the reconfigurable waveguide arrangement 403R, 403F is changed, being shortened. A waveguide part 4010 that is directly connected to the antenna port 401 is moved in the same manner. At least one or more surfaces 406a, 406b; 407a, 407b; 411, 412 are at least partly at least partly comprises protruding elements 413 in the same manner as described previously.

In FIG. 4C, a top view of the bottom layer 435 in the fixed part 430 is shown. It is evident that if the bottom layer 435 is moved to the right in the Figure, a reconfigurable waveguide conductor part 403′R in the reconfigurable waveguide arrangement 403′R, 403′F is changed, being shortened. A waveguide part 4010′ that is directly connected to the antenna port 401 is moved in the same manner. At least one or more surfaces 408a, 408b; 409a, 409b; 411′, 412′ are at least partly at least partly comprises protruding elements 413 in the same manner as described previously.

It is to be noted that the wall parts 433, 434 have different widths along their extensions.

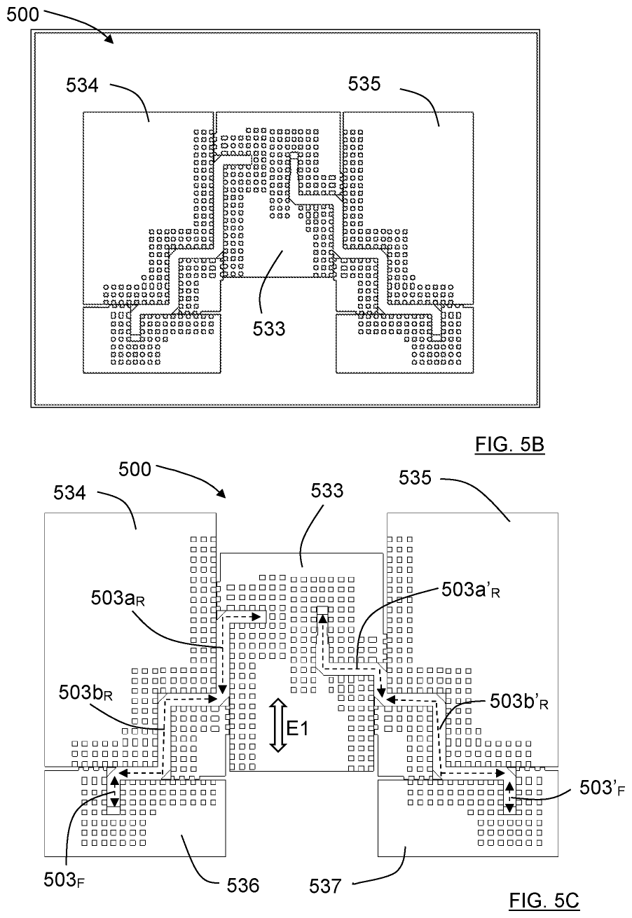

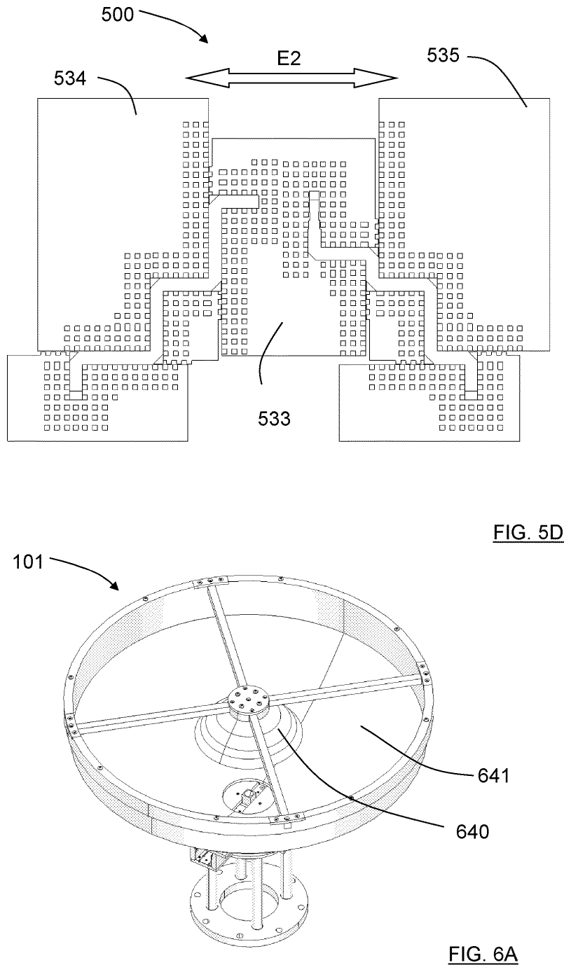

With reference to FIG. 5A-5D, there is a fourth example of an antenna feed arrangement 500. According to some aspects, the antenna feed arrangement 500 comprises a fixed bottom part 531, a movable top part 532 and at least two intermediate movable parts 533, 534, 535, where at least a first intermediate movable part 533 is adapted to move together with the movable top part 532 along a first extension E1 and where at least two intermediate movable parts 533, 534, 535, including said first intermediate movable part 533, are adapted to move together with the movable top part 532 along a second extension E2, perpendicular to the first extension E1.

In this manner, a two-dimensional movement can be accomplished.

According to some aspects, the fixed bottom part 531 comprises a first waveguide port 502 and a second waveguide port 502′, and the movable top part 532 comprises an antenna port 501. The antenna port 501 may constitute an antenna feed in itself.

According to some aspects, the movable top part 532 comprises two separate parts 532A, 532B that are fixed relative each other, where a gap 551 between these parts 532A, 532B is formed by adjacent surfaces 550a, 550b where one of these surfaces comprises the protruding elements 532 according to the above.

In FIG. 5B, FIG. 5C and FIG. 5D, the beemsteering mechanism is exemplified. In this example, there are three intermediate movable parts 533, 534, 535, a first intermediate movable part 533 that at least partly comprises a first reconfigurable waveguide conductor part 503a_{R} and a second reconfigurable waveguide conductor part 503a′_{R}, a second intermediate movable part 534 that at least partly comprises a third reconfigurable waveguide conductor part 503b_{R} and a third intermediate movable part 535 that at least partly comprises a fourth reconfigurable waveguide conductor part 503b′_{R}. In the same layer, there are also two intermediate fixed parts which 536, 537 that comprises a corresponding fixed waveguide conductor part 503F, 503′_{F} that is connected to the corresponding waveguide port 502, 502′.

The reconfigurable waveguide arrangement thus comprises four reconfigurable waveguide conductor parts 503a_{R}, 503a′_{R}, 503b_{R}, 503b′_{R} and two fixed waveguide conductor parts 503F, 503′_{F}. As shown in FIG. 5C, the first intermediate movable part 533 is moved along the first extension E1 together with the movable top part 532 with the antenna port 501 such that the first reconfigurable waveguide conductor part 503a_{R} and second reconfigurable waveguide conductor part 503a′_{R} are shortened or lengthened depending on the movement direction along the first extension E1. In this way, the position of the antenna port 502 is altered along the first extension E1, allowing beemsteering.

FIG. 5B shows a schematic top section view of FIG. 5A where the antenna feed arrangement is in a first, position. FIG. 5C and FIG. 5D shows the antenna feed arrangement is in a second, respective third, position.

As shown in FIG. 5D, the first intermediate movable part 533 is moved along the second extension E2 together with the movable top part 532 with the antenna port 501 and together with the second intermediate movable part 534 and the third intermediate movable part 535. One of the third reconfigurable waveguide conductor part 503b_{R} and the fourth reconfigurable waveguide conductor part 503b′_{R} is shortened and the other one is lengthened, and which one that is shortened and which on that is lengthened depends on the movement direction along the first extension E1. In this way, the position of the antenna port 502 is altered along the second extension E2, allowing beemsteering.

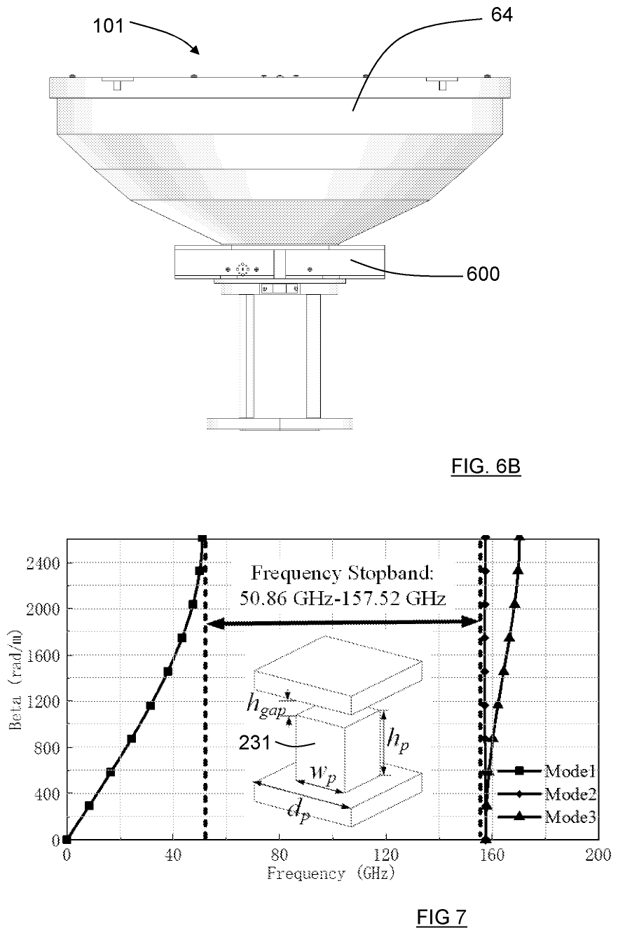

With reference to FIG. 6A and FIG. 6B, the present disclosure also relates to a radio link antenna 102 comprising a source antenna 640, a collimating part 641 and an antenna feed arrangement 600 as described herein. For example, the collimating part 641 is constituted by a reflector which is illuminated by the feed or source antenna 640. The function of the collimating part 641 is to convert the radiation pattern of the source antenna 640 into a radiation pattern with a relatively very high degree of directivity.

The radio link antenna 102 can thus be a dual-reflector antenna, including Gregorian, Cassegrain reflector antenna or other types of dual reflector antennas where the feed arrangement for example can be a horn antenna, a slot antenna, a microstrip patch antenna or any other suitable type of antenna.

With reference to FIG. 1, the present disclosure also relates to a radio link node 101A, 101B comprising a radio link antenna 102A, 102B as described herein, and a radio unit (103A, 103B), where the antenna feed arrangement 200A, 200B is adapted to connect the link antenna 102A, 102B to the radio unit 103A, 103B.

The present disclosure also relates to a radio link arrangement 100 comprising at least two radio link nodes 101A, 101B as described herein, where the radio link nodes 101A, 101B are adapted to communicate with each other via a corresponding communication link 106.

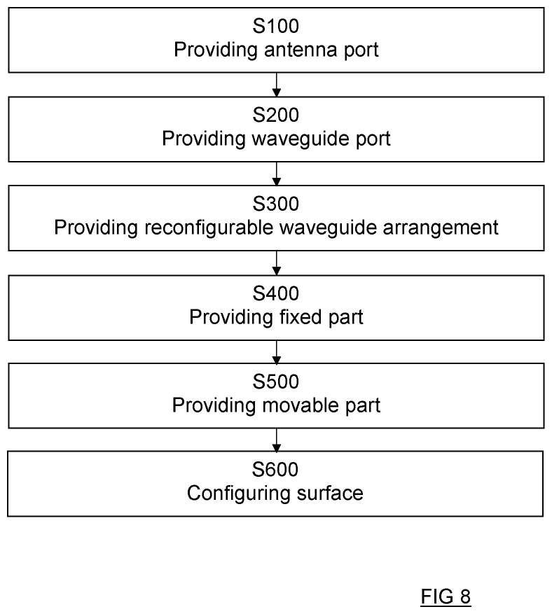

With reference to FIG. 8, the present disclosure also relates to a method for configuring an antenna feed arrangement 200. The method comprises providing S100 an antenna port 201, providing S200 a waveguide port 202, and providing S300 a reconfigurable waveguide arrangement 203R, 203F connecting the antenna port 201 and the waveguide port 202. The method further comprises providing S400 a fixed part 205A, 205B that comprises the waveguide port 202, said fixed part 205A, 205B having a fixed position in the feed arrangement 200, and providing S500 a movable part 204A, 204B that in turn comprises the antenna port 201, where said movable part 204A, 204B is movable relative said fixed part 205A, 205B by means of pairs of variable adjacent surfaces 206a, 206b; 207a, 206b; 208a, 208b; 209a, 209b; 210a, 210c; 211a, 210c that are adapted to move relative each other.

The method also comprises configuring S600 one surface 206a, 207a, 208a, 209b, 210a, 211a in at least one pair of variable adjacent surfaces 206a, 206b; 207a, 206b; 208a, 208b; 209a, 209b; 210a, 210c; 211a, 210c such that it at least partly comprises a conductive material with a periodic or quasi-periodic structure formed by a number of protruding elements 213 arranged or designed to stop propagation of microwave energy to pass across a gap 214, 215, 216, 217 between the variable adjacent surfaces 206a, 206b; 207a, 206b; 208a, 208b; 209a, 209b; 210a, 210c; 211a, 210c in at least one direction D1, D2, D3, D4, at least in one intended frequency band of operation.

According to some aspects, the feed arrangement 200 comprises at least one waveguide port 202, at least one fixed part 205A, 205B and at least one movable part 204A, 204B.

The present disclosure is not limited to the above, but may vary freely within the scope of the appended claims. For example, each one of the point to point radio links can be any form of point to point radio links such as for example microwave links.

According to some aspects, a point to point radio link may be comprised in a point to point radio link network that in turn can comprise more than one point to point radio link, and thus more than two point to point radio link transceivers.

According to some aspects, the collimating device is constituted by a lens device.

According to some aspects the antenna feed arrangement as described herein can be used for many types of antennas where a movement of the feed antenna changes the radiation pattern; single reflector with hat feed, dual reflector, offset reflector, lens antenna, or the horn alone, relfectarray, etc.

Other examples are
Reflector antennas where the feed is a hat feed antenna. This enables beam steering of a single reflector antenna.
Self-support dual-reflector systems, where the entire sub-reflector is moved together with the feed arrangement.
Offset fed reflector antennas where the radio unit and antenna feed arrangement are placed to the side of the reflector.

By means of the present disclosure, lateral movement of a high-gain pencil beam antenna, is enabled as well as titling of a high-gain pencil beam antenna, for example a horn antenna or lens antenna.

According to some aspects, the present disclosure achieves high-gain beam tracking by moving an antenna feed arrangement in the reflector system, and in order to avoid bending of a cable connected to a waveguide port, the waveguide port connected to the cable needs to remain stationary, which requires internal movement of the antenna. In order to solve the energy leakage and undesired resonance caused by the gap generated by the relative motion inside the antenna, a periodic or quasi-periodic structure formed by a number of protruding elements as described herein is used.

1. An antenna feed arrangement comprising an antenna port, a waveguide port and a reconfigurable waveguide arrangement connecting the antenna port and the waveguide port, where the feed arrangement comprises:
a fixed part that comprises the waveguide port, the fixed part having a fixed position in the feed arrangement; and
a movable part that in turn comprises the antenna port, where the movable part is movable relative the fixed part by means of pairs of variable adjacent surfaces that are adapted to move relative each other;
wherein one surface in at least one pair of variable adjacent surfaces at least partly comprises a conductive material with a periodic or quasi-periodic structure formed by a number of protruding elements arranged or designed to stop propagation of microwave energy to pass across a gap between the variable adjacent surfaces in at least one direction, at least in one intended frequency band of operation.

2. The antenna feed arrangement according to claim 1, wherein the feed arrangement comprises at least one waveguide port, at least one fixed part and at least one movable part.

3. The antenna feed arrangement according to claim 1, wherein at least one movable part at least partly comprises at least one reconfigurable waveguide conductor part that is comprised in the reconfigurable waveguide arrangement and connects to the antenna port such that when the movable part is moved, the antenna port is moved relative the waveguide port that is kept fixed while maintaining the connection between the antenna port and the waveguide port via the waveguide arrangement.

4. The antenna feed arrangement according to claim 1, wherein the feed arrangement comprises pairs of fixed adjacent surfaces that are adapted to have a fixed position relative each other, where one surface in at least one pair of fixed adjacent surfaces comprises a surface of a conductive material with a periodic or quasi-periodic structure formed by the protruding elements.

5. The antenna feed arrangement according to claim 1, further comprising a first layer that is a fixed part and comprises an electrically conducting first main surface, a second layer that is a fixed part and comprises an electrically conducting second main surface that faces the first main surface, and a third layer that is positioned between the first main surface and the second main surface, where the third layer comprises at least one movable part and at least one fixed part, where the reconfigurable waveguide arrangement is formed in the movable part and the fixed part, forming a connection between the antenna port and a waveguide port, where a movement of the movable part changes the position of the antenna port relative the waveguide port while the connection via the reconfigurable waveguide arrangement between the antenna port and the waveguide port is maintained.

6. The antenna feed arrangement according to claim 1, wherein a movement of the movable part is a circular movement around a center axis.

7. The antenna feed arrangement according to claim 1, further comprising a U-shaped fixed part that comprises at least one waveguide port, and a movable part that is slidably arranged in the fixed part and comprises the antenna port, where at least one reconfigurable waveguide conductor part is at least partly formed in the movable part, where a movement of the movable part changes the position of the antenna port relative the waveguide port while maintaining the connection via the reconfigurable waveguide arrangement between the antenna port and the waveguide port.

8. The antenna feed arrangement according to claim 7, wherein the fixed part comprises a bottom part, a first wall part and a second wall part, where the movable part is slidably arranged on the bottom part and between the wall parts, where the first wall part comprises a first waveguide port and the second wall part comprises a second waveguide port, the waveguide ports being positioned at different distances from the bottom layer, and where the movable part comprises a bottom layer, a top layer, and an intermediate layer positioned between the bottom layer and the top layer, where the bottom layer comprises a first reconfigurable waveguide arrangement that is adapted to form a part of a connection between the first waveguide port and the antenna port, where the intermediate layer comprises a second reconfigurable waveguide arrangement that is adapted to form a part of a connection between the second waveguide port and the antenna port, and where the top layer comprises the antenna port.

9. The antenna feed arrangement according to claim 1, further comprising a fixed bottom part, a movable top part and at least two intermediate movable parts, where at least a first intermediate movable part is adapted to move together with the movable top part along a first extension and where at least two intermediate movable parts, including the first intermediate movable part, are adapted to move together with the movable top part along a second extension, perpendicular to the first extension.

10. The antenna feed arrangement according to claim 9, wherein the fixed bottom part comprises a first waveguide port and a second waveguide port, and where the movable top part comprises an antenna port.

11. A radio link antenna comprising a source antenna, a collimating part and the antenna feed arrangement according to claim 1.

12. A radio link node comprising the radio link antenna according to claim 11 and a radio unit, where the antenna feed arrangement is adapted to connect the link antenna to the radio unit.

13. A radio link arrangement comprising at least two of the radio link nodes according to claim 12, where the radio link nodes are adapted to communicate with each other via a corresponding communication link.

14. A method for configuring an antenna feed arrangement, the method comprising:
providing an antenna port;
providing a waveguide port; and
providing a reconfigurable waveguide arrangement connecting the antenna port and the waveguide port;
wherein the method further comprises:
providing a fixed part that comprises the waveguide port, the fixed part having a fixed position in the feed arrangement;
providing a movable part that in turn comprises the antenna port, where the movable part is movable relative the fixed part by means of pairs of variable adjacent surfaces that are adapted to move relative each other; and
configuring one surface in at least one pair of variable adjacent surfaces such that it at least partly comprises a conductive material with a periodic or quasi-periodic structure formed by a number of protruding elements arranged or designed to stop propagation of microwave energy to pass across a gap between the variable adjacent surfaces in at least one direction, at least in one intended frequency band of operation.

15. The method according to claim 14, wherein the feed arrangement comprises at least one waveguide port, at least one fixed part and at least one movable part.
